(19) United States
(12) Patent Application Publication
(10) Pub. No.: US 2010/0233363 A1
(43) Pub. Date: Sep. 16, 2010

(54) METHOD OF MANUFACTURING RESIN MOLDED ARTICLE, INKJET HEAD AND ELECTRONIC DEVICE

(76) Inventor: Hiroki Uchiyama, Ashigarakami-gun (JP)

Correspondence Address: FISH & RICHARDSON P.C., PO BOX 1022, MINNEAPOLIS, MN, 55440-1022, US

(21) Appl. No.: 12/723,516

(22) Filed: Mar. 12, 2010

(30) Foreign Application Priority Data
Mar. 13, 2009 (JP) 2009061681

(51) Int. Cl. C09D 5/20; B41J 2/01

(52) U.S. Cl. 427/155; 347/1

(57) ABSTRACT

A method of manufacturing a resin molded article includes: a fluorination step of carrying out fluorination processing using a gas containing fluorine so as to form a lyophobic layer on at least a portion of a face of a base material made of resin; a protective member formation step of forming a protective member on the portion of the face of the base material where the lyophobic layer has been formed; a lyophobic layer removal step of, on the face of the base material where the protective member has not been formed, removing the lyophobic layer formed and simultaneously carrying out lyophilic processing; and a protective member removal step of removing the protective member.

### BACKGROUND OF THE INVENTION

1. Field of the Invention

The present invention relates to a method of manufacturing a resin molded article, an inkjet head and an electronic device, and more particularly, to technology for manufacturing a resin molded article having a lyophobic surface and a lyophilic surface in at least one portion of a base material composed of resin.

2. Description of the Related Art

In general, an inkjet recording apparatus records a desired image on a recording medium by ejecting ink droplets from the respective nozzles while moving a recording head (inkjet head) having a plurality of nozzles and a recording medium relatively with respect to each other. Inkjet recording apparatuses are used in a wide range of fields from commercial to industrial applications, due to their excellent noise characteristics, low running costs, and their capacity to record images of high quality onto recording media of many various types.

Using resin in an inkjet head is beneficial in comparison with glass or metal, since it enables low-cost manufacture and simple processing and assembly. However, if an aqueous ink is used in an inkjet head made of resin, since the inner wall faces of nozzles have high lyophobic properties, the wetting properties for the aqueous ink are poor, and therefore air bubbles become trapped inside the ink flow channels during replenishment of ink, it is difficult to expel the air bubbles which occur inside the flow channels even if an expelling operation is carried out, and recording failures occur due to problems such as dot omissions, print disturbances, and the like. On the other hand, if the ink ejection surface (nozzle surface) of an inkjet head made of resin does not have sufficient lyophobic properties, then ink dripping can occur when the ink is ejected and the ejection stability and directionality can become worse.

In order to resolve the problems described above, Japanese Patent Application Publication No. 5-338180 discloses technology according to which a fluorine-containing polymer film is formed as a lyophobic film (hydrophobic film) on the ink ejection surface of an inkjet head made of resin, whereupon a hydrophilization process for forming an oxide layer is carried out on the inner wall faces of the nozzles.

Further, Japanese Patent Application Publication No. 2005-93989 discloses a surface treatment method for a print substrate which exposes a print substrate comprising at least a surface layer made from a polyimide film, to ozone gas in which the concentration of ozone gas is 3-50 vol % under the atmosphere of normal temperature to 200° C., so that the surface of the polyimide film is chemically treated so as to improve the hydrophilic property.

However, in the technology disclosed in Japanese Patent Application Publication No. 5-338180, it is necessary to form a lyophobic film and a lyophilic film separately on a base material which has a complex structure in which nozzles and flow channels are formed, and productivity becomes low due to the increase in the number of processing steps. Furthermore, there are issues in achieving close adhesion to the base material and uniform coverage over the base of the base material. Moreover, a lyophobic film and a lyophilic film are formed by a wet process, and therefore the problems described above are more pronounced (similar problems also occur with a dry process). Furthermore, Japanese Patent Application Publication No. 5-338180 describes making it possible readily to detach a lyophilic film which has been formed on a lyophobic film after forming a lyophobic film, but does not give a description of specific methods and furthermore, in practice, it is difficult to remove the lyophilic film on the lyophobic film completely.

### SUMMARY OF THE INVENTION

The present invention has been contrived in view of these circumstances, an object thereof being to provide a method of manufacturing a resin molded article whereby a resin molded article having a lyophobic surface and a lyophilic surface can be processed uniformly by means of a simple process.

A further object of the present invention is to provide an inkjet head and an electronic device which comprise a resin molded article manufactured by the method of manufacturing a resin molded article and have excellent ejection performance, reliability and maintenance properties.

In order to attain an object described above, one aspect of the present invention is directed to a method of manufacturing a resin molded article, comprising: a fluorination step of carrying out fluorination processing using a gas containing fluorine so as to form a lyophobic layer on at least a portion of a face of a base material made of resin; a protective member formation step of forming a protective member on the portion of the face of the base material where the lyophobic layer has been formed; a lyophobic layer removal step of, on the face of the base material where the protective member has not been formed, removing the lyophobic layer formed and simultaneously carrying out lyophilic processing; and a protective member removal step of removing the protective member.

According to this aspect of the invention, by forming a lyophobic layer by fluorination processing on at least a portion of the face of a base material made of resin and then removing a portion of the lyophobic layer while simultaneously performing lyophilic processing, it is possible to manufacture a resin molded article having a lyophobic surface and a lyophilic surface by means of a simple process. Furthermore, by adopting gas processing by a fluorination process, then uniform processing (surface uniformity and conformal properties, and the like) can be achieved irrespectively of the shape of the base material, and low-temperature processing is also possible. Moreover, it is not necessary to take account of the coverage of the base material.

A desirable mode of the present invention is one where the fluorination processing uses a mixed gas containing fluorine gas and an inert gas. According to this mode, it is possible to stabilize the fluorination processing. Helium, argon, nitrogen, or the like, is used as the inert gas.

A further desirable mode of the present invention is one where the lyophobic layer is removed by means of plasma processing, acid processing, discharge processing, ultraviolet processing, electron beam processing, radiation processing or ozone gas processing. By means of these processes, it is possible to remove the lyophobic layer from the face of the base material where the protective member has not been formed, while simultaneously performing lyophilic processing.

Of these processes, plasma processing (and desirably, plasma processing using a gas containing oxygen), ultraviolet processing and ozone gas processing (and desirably, high-purity ozone gas processing) are most desirable, and enable improvement of the lyophilic properties of the face where the lyophobic layer has been removed.

A further desirable mode of the present invention is one which includes a lyophilic processing step of carrying out additional lyophilic processing on the face of the base material where the lyophobic layer has been removed, after the lyophobic layer removal step. According to this mode, it is possible further to enhance the lyophilic properties of the face where the lyophobic layer has been removed.

A desirable mode is one where the lyophilic processing step is carried out by gas processing. According to this mode, it is possible to carry out lyophilic processing uniformly, without irregularities, as well as being able to form a lyophilic layer having excellent temporal stability compared to other processes (such as plasma processing). A desirable mode of the gas processing is a mode using ozone gas and a mode using a mixed gas of fluorine gas and oxygen gas.

In a mode which uses a mixed gas of fluorine gas and oxygen gas, more desirably, the base material is exposed to a water vapor atmosphere after being exposed to the mixed gas atmosphere. In this case, it is possible to adopt a mode in which water vapor is introduced without removing the mixed gas inside the processing vessel (chamber), or a mode in which water vapor is introduced into the processing vessel after removing the mixed gas. However, the latter mode is desirable from the viewpoint of stabilizing the lyophilic processing.

The lyophilic step may be carried out before the protective member removal step.

The lyophilic step may be carried out after the protective member removal step.

Desirably, a hole section to form a liquid flow channel is provided in the base material, the lyophobic layer is formed by subjecting a surface of the base material and an inner wall face of the hole section to the fluorination processing, the protective member is formed on the lyophobic layer on the surface of the base material, the lyophobic layer formed on the inner wall face of the hole section is removed while simultaneously the lyophilic processing is carried out on the inner wall face of the holes section, and then the protective member is removed.

According to this mode, it is possible to obtain a resin molded article in which an inner wall face of a liquid flow channel (hole section) are rendered lyophilic and the surface of the base material is rendered lyophobic. This improves the expulsion of air bubbles which have become mixed into the liquid flow channels, as well as making it possible to remove the liquid adhering to the surface of the base material.

A more desirable mode is one in which the base material is a nozzle forming substrate in which a nozzle hole are formed. In this case, it is possible to form a nozzle plate (resin structural body) having excellent ejection stability and maintenance characteristics.

Desirably, the protective member is a detachable tape.

Desirably, the detachable tape has a removable acrylic adhesive.

Desirably, the detachable tape has a base made from a polyester film or a polyethylene film.

In order to attain an object described above, another aspect of the present invention is directed to an inkjet head comprising a resin molded article manufactured by one of the methods of manufacturing a resin molded article described above.

In order to attain an object described above, another aspect of the present invention is directed to an electronic device comprising one of the inkjet heads described above.

According to the present invention, by forming a lyophobic layer by fluorination processing on at least a portion of the surface of a base material made of resin and then removing a portion of the lyophobic layer while simultaneously performing lyophilic processing, it is possible to manufacture a resin molded article having a lyophobic surface and a lyophilic surface by means of a simple process. Furthermore, by adopting gas processing by a fluorination process, then uniform processing (surface uniformity and conformal properties, and the like) can be achieved irrespectively of the shape of the base material, and low-temperature processing is also possible. Moreover, it is not necessary to take account of the coverage of the base material.

### BRIEF DESCRIPTION OF THE DRAWINGS

FIG. 1 is a general schematic drawing showing a general view of an inkjet recording apparatus;

FIG. 2 is a principal plan diagram of the peripheral area of a printing unit in the inkjet recording apparatus illustrated in FIG. 1;

FIGS. 3A to 3C are plan view perspective diagrams showing examples of the composition of a printing head;

FIG. 4 is a cross-sectional diagram along line IV-IV in FIGS. 3A and 3B;

FIGS. 5A to 5E are illustrative diagrams showing a lyophobic treatment method relating to a first embodiment;

FIG. 6 is an illustrative diagram showing an aspect of a fluorination process;

FIGS. 7A to 7F are illustrative diagrams showing a lyophobic treatment method relating to a second embodiment; and

FIG. 8 is an illustrative diagram showing an aspect of a fluorination process upon introduction of water vapor.

### DETAILED DESCRIPTION OF THE PREFERRED EMBODIMENTS

### General Configuration of Inkjet Recording Apparatus

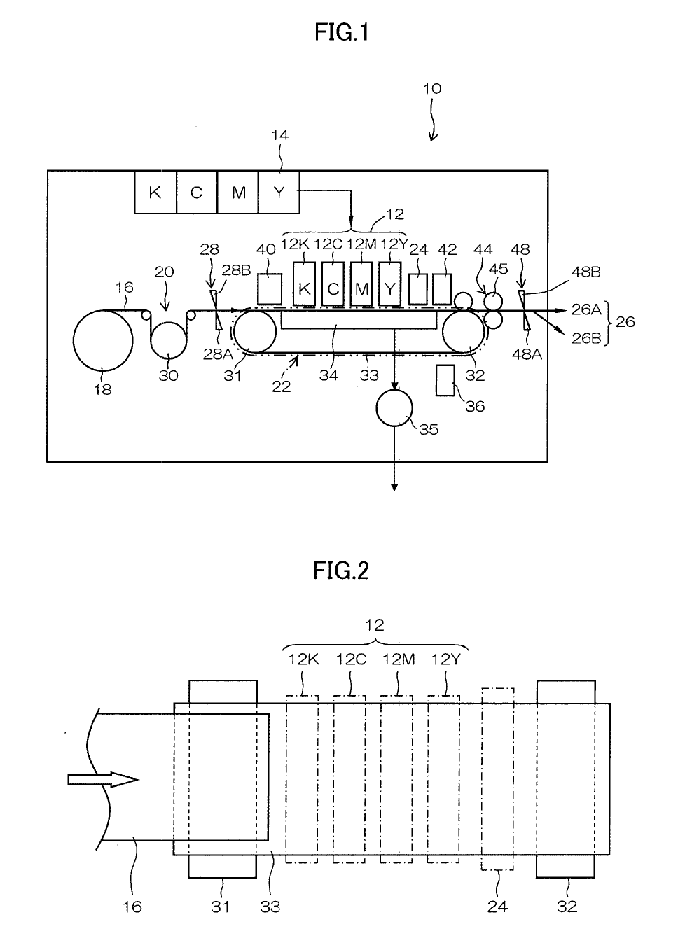

FIG. 1 is a general configuration diagram of one embodiment of an inkjet recording apparatus according to an embodiment of the present invention. As illustrated in FIG. 1, the inkjet recording apparatus 10 comprises: a printing unit 12 having a plurality of inkjet heads (hereafter, also simply called “heads”) 12K, 12C, 12M, and 12Y provided for the respective ink colors; an ink storing and loading unit 14 for storing inks of K, C, M and Y to be supplied to the printing heads 12K, 12C, 12M, and 12Y; a paper supply unit 18 for supplying recording paper 16; a decurling unit 20 removing curl in the recording paper 16; a suction belt conveyance unit 22 disposed facing the nozzle face (ink-droplet ejection face) of the printing unit 12, for conveying the recording paper 16 while keeping the recording paper 16 flat; a print determination unit 24 for reading the printed result produced by the printing unit 12; and a paper output unit 26 for outputting image-printed paper (printed matter) to the exterior.

In FIG. 1, a magazine for rolled paper (continuous paper) is shown as an example of the paper supply unit 18; however, more magazines with paper differences such as paper width and quality may be jointly provided. Moreover, papers may be supplied with cassettes that contain cut papers loaded in layers and that are used jointly or in lieu of the magazine for rolled paper.

In the case of the configuration in which roll paper is used, a cutter 28 is provided as illustrated in FIG. 1, and the continuous paper is cut into a desired size by the cutter 28. The cutter 28 has a stationary blade 28A, whose length is not less than the width of the conveyor pathway of the recording paper 16, and a round blade 28B, which moves along the stationary blade 28A. The stationary blade 28A is disposed on the reverse side of the printed surface of the recording paper 16, and the round blade 28B is disposed on the printed surface side across the conveyor pathway. When cut papers are used, the cutter 28 is not required.

In the case of a configuration in which a plurality of types of recording paper can be used, it is desirable that an information recording medium such as a bar code and a wireless tag containing information about the type of paper is attached to the magazine, and by reading the information contained in the information recording medium with a predetermined reading device, the type of paper to be used is automatically determined, and ink-droplet ejection is controlled so that the ink-droplets are ejected in an appropriate manner in accordance with the type of paper.

The recording paper 16 delivered from the paper supply unit 18 retains curl due to having been loaded in the magazine. In order to remove the curl, heat is applied to the recording paper 16 in the decurling unit 20 by a heating drum 30 in the direction opposite from the curl direction in the magazine. The heating temperature at this time is desirably controlled so that the recording paper 16 has a curl in which the surface on which the print is to be made is slightly round outward.

The decurled and cut recording paper 16 is delivered to the suction belt conveyance unit 22. The suction belt conveyance unit 22 has a configuration in which an endless belt 33 is set around rollers 31 and 32 so that the portion of the endless belt 33 facing at least the nozzle face of the printing unit 12 and the sensor face of the print determination unit 24 forms a plane.

The belt 33 has a width that is greater than the width of the recording paper 16, and a plurality of suction apertures (not shown) are formed on the belt surface. A suction chamber 34 is disposed in a position facing the sensor surface of the print determination unit 24 and the nozzle surface of the printing unit 12 on the interior side of the belt 33, which is set around the rollers 31 and 32, as illustrated in FIG. 1. The suction chamber 34 provides suction with a fan 35 to generate a negative pressure, and the recording paper 16 on the belt 33 is held by suction.

The belt 33 is driven in the clockwise direction in FIG. 1 by the motive force of a motor (not shown) being transmitted to at least one of the rollers 31 and 32, which the belt 33 is set around, and the recording paper 16 held on the belt 33 is conveyed from left to right in FIG. 1.

Since ink adheres to the belt 33 when a marginless print job or the like is performed, a belt-cleaning unit 36 is disposed in a predetermined position (a suitable position outside the printing area) on the exterior side of the belt 33. Although the details of the configuration of the belt-cleaning unit 36 are not shown, examples thereof include a configuration in which the belt 33 is nipped with cleaning rollers such as a brush roller and a water absorbent roller, an air blow configuration in which clean air is blown onto the belt 33, and a combination of these. In the case of the configuration in which the belt 33 is nipped with the cleaning rollers, it is desirable to make the line velocity of the cleaning rollers different from that of the belt 33 to improve the cleaning effect.

A roller nip conveyance mechanism, in place of the suction belt conveyance unit 22, can be employed. However, there is a drawback in the roller nip conveyance mechanism that the print tends to be smeared when the printing area is conveyed by the roller nip action because the nip roller makes contact with the printed surface of the paper immediately after printing. Therefore, the suction belt conveyance in which nothing comes into contact with the image surface in the printing area is desirable.

A heating fan 40 is disposed on the upstream side of the printing unit 12 in the conveyance pathway formed by the suction belt conveyance unit 22. The heating fan 40 blows heated air onto the recording paper 16 to heat the recording paper 16 immediately before printing so that the ink deposited on the recording paper 16 dries more easily.

The printing unit 12 is a so-called “full line head” in which a line head having a length corresponding to the maximum paper width is arranged in a direction (main scanning direction) that is perpendicular to the paper conveyance direction (sub scanning direction). Each of the printing heads 12K, 12C, 12M, and 12Y constituting the printing unit 12 is constituted by a line head, in which a plurality of ink ejection ports (nozzles) are arranged along a length that exceeds at least one side of the maximum-size recording paper 16 intended for use in the inkjet recording apparatus 10 (see FIG. 2).

The printing heads 12K, 12C, 12M, and 12Y are arranged in the order of black (K), cyan (C), magenta (M), and yellow (Y) from the upstream side, along the feed direction of the recording paper 16 (hereinafter, referred to as the sub-scanning direction). A color image can be formed on the recording paper 16 by ejecting the inks from the printing heads 12K, 12C, 12M, and 12Y, respectively, onto the recording paper 16 while conveying the recording paper 16.

By adopting the printing unit 12 in which the full line heads covering the full paper width are provided for the respective ink colors in this way, it is possible to record an image on the full surface of the recording paper 16 by performing just one operation of relatively moving the recording paper 16 and the printing unit 12 in the paper conveyance direction (the sub-scanning direction), in other words, by means of a single sub-scanning action. Higher-speed printing is thereby made possible and productivity can be improved in comparison with a shuttle type head configuration in which a head reciprocates in a direction (the main scanning direction) orthogonal to the paper conveyance direction.

Although the configuration with the KCMY four standard colors is described in the present embodiment, combinations of the ink colors and the number of colors are not limited to those. Light inks or dark inks can be added as required. For example, a configuration is possible in which heads for ejecting light-colored inks such as light cyan and light magenta are added. Furthermore, there are no particular restrictions of the sequence in which the heads of respective colors are arranged.

As illustrated in FIG. 1, the ink storing and loading unit 14 has tanks for storing the inks of K, C, M and Y to be supplied to the heads 12K, 12C, 12M, and 12Y, and the tanks are connected to the heads 12K, 12C, 12M, and 12Y by means of channels, which are omitted from figures. The ink storing and loading unit 14 has a warning device (for example, a display device or an alarm sound generator) for warning when the remaining amount of any ink is low, and has a mechanism for preventing loading errors among the colors.

The print determination unit 24 has an image sensor (line sensor) for capturing an image of the ink-droplet deposition result of the printing unit 12, and functions as a device to check for ejection defects such as clogs of the nozzles in the printing unit 12 from the ink-droplet deposition results evaluated by the image sensor.

The print determination unit 24 of the present embodiment is configured with at least a line sensor having rows of photoelectric transducing elements with a width that is greater than the ink-droplet ejection width (image recording width) of the heads 12K, 12C, 12M, and 12Y. This line sensor has a color separation line CCD sensor including a red (R) sensor row composed of photoelectric transducing elements (pixels) arranged in a line provided with an R filter, a green (G) sensor row with a G filter, and a blue (B) sensor row with a B filter. Instead of a line sensor, it is possible to use an area sensor composed of photoelectric transducing elements which are arranged two-dimensionally.

The print determination unit 24 reads a test pattern image printed by the heads 12K, 12C, 12M, and 12Y for the respective colors, and the ejection of each head is determined The ejection determination includes measurement of the presence of the ejection, measurement of the dot size, and measurement of the dot deposition position.

A post-drying unit 42 is disposed following the print determination unit 24. The post-drying unit 42 is a device to dry the printed image surface, and includes a heating fan, for example. It is desirable to avoid contact with the printed surface until the printed ink dries, and a device that blows heated air onto the printed surface is desirable.

In cases in which printing is performed with dye-based ink on porous paper, blocking the pores of the paper by the application of pressure prevents the ink from coming contact with ozone and other substances that cause dye molecules to break down, and has the effect of increasing the durability of the print.

A heating/pressurizing unit 44 is disposed following the post-drying unit 42. The heating/pressurizing unit 44 is a device to control the glossiness of the image surface, and the image surface is pressed with a pressure roller 45 having a predetermined uneven surface shape while the image surface is heated, and the uneven shape is transferred to the image surface.

The printed matter generated in this manner is outputted from the paper output unit 26. The target print (i.e., the result of printing the target image) and the test print are desirably outputted separately. In the inkjet recording apparatus 10, a sorting device (not shown) is provided for switching the outputting pathways in order to sort the printed matter with the target print and the printed matter with the test print, and to send them to paper output units 26A and 26B, respectively. When the target print and the test print are simultaneously formed in parallel on the same large sheet of paper, the test print portion is cut and separated by a cutter (second cutter) 48. The cutter 48 is disposed directly in front of the paper output unit 26, and is used for cutting the test print portion from the target print portion when a test print has been performed in the blank portion of the target print. The structure of the cutter 48 is the same as the first cutter 28 described above, and has a stationary blade 48A and a round blade 48B.

Although not illustrated in FIG. 1, the paper output unit 26A for the target prints is provided with a sorter for collecting prints according to print orders.

### Structure of the Head

Next, the structure of heads 12K, 12C, 12M and 12Y will be described. The heads 12K, 12C, 12M and 12Y of the respective ink colors have the same structure, and a reference numeral 50 is hereinafter designated to any of the heads.

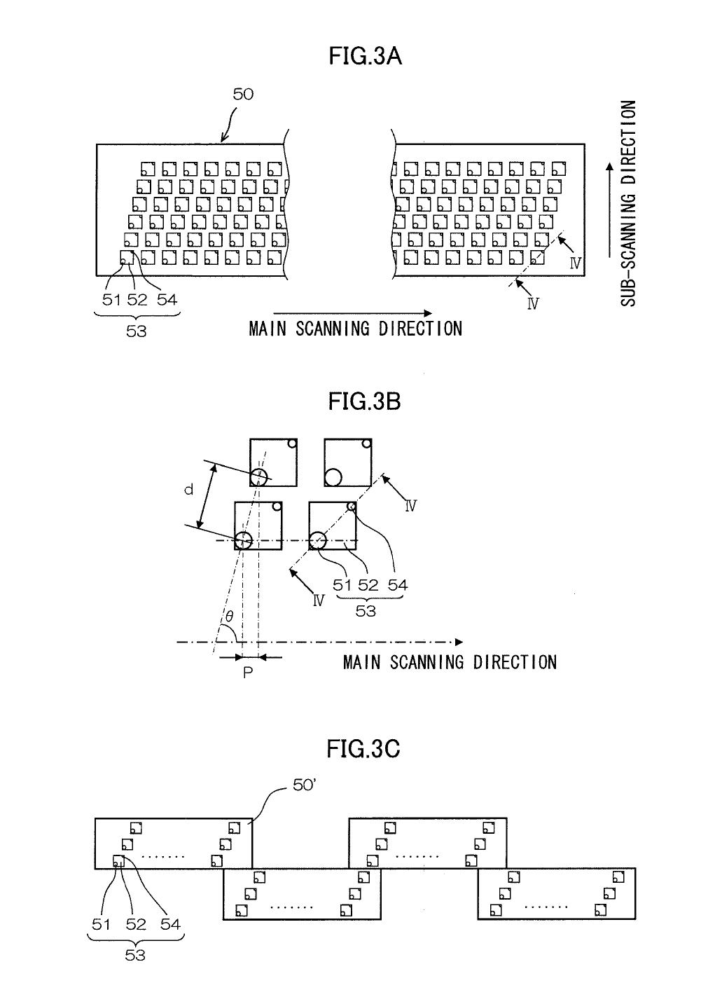

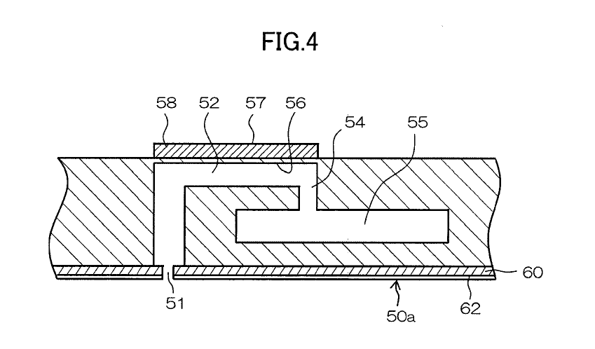

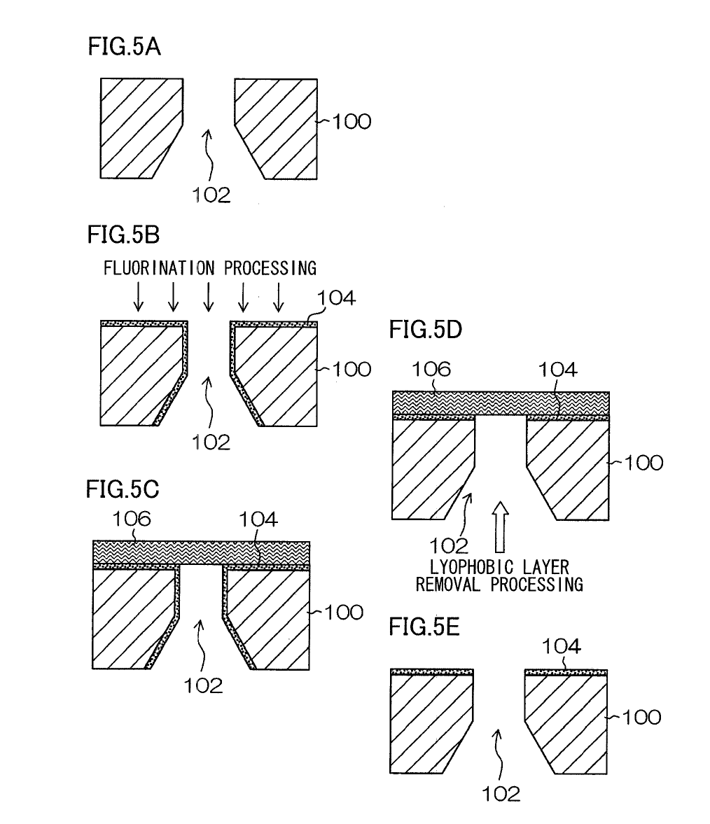

FIG. 3A is a plan perspective diagram showing an example of the structure of a head 50, and FIG. 3B is a partial enlarged diagram of same. Moreover, FIG. 3C is a plan view perspective diagram showing a further example of the structure of the head 50. FIG. 4 is a cross-sectional diagram showing the composition of an ink chamber unit (a cross-sectional diagram along line IV-IV in FIGS. 3A and 3B). Furthermore, FIGS. 5A to 5E are flow channel composition diagrams showing the structure of flow channels inside the head 50 (a plan view perspective diagram in direction A in FIG. 4).

The nozzle pitch in the head 50 should be minimized in order to maximize the density of the dots formed on the surface of the recording paper. As illustrated in FIGS. 3A and 3B, the head 50 according to the present embodiment has a structure in which a plurality of ink chamber units 53, each comprising a nozzle 51 forming an ink droplet ejection hole, a pressure chamber 52 corresponding to the nozzle 51, and the like, are disposed two-dimensionally in the form of a staggered matrix, and hence the effective nozzle interval (the projected nozzle pitch) as projected in the lengthwise direction of the head (the main scanning direction perpendicular to the paper conveyance direction) is reduced and high nozzle density is achieved.

The mode of forming one or more nozzle rows through a length corresponding to the entire width of the recording paper 16 in a direction substantially perpendicular to the paper conveyance direction is not limited to the example described above. For example, instead of the configuration in FIG. 3A, as illustrated in FIG. 3C, a line head having nozzle rows of a length corresponding to the entire width of the recording paper 16 can be formed by arranging and combining, in a staggered matrix, short head blocks (head chips) 50′ having a plurality of nozzles 51 arrayed in a two-dimensional fashion. Furthermore, although not shown in the drawings, it is also possible to compose a line head by arranging short heads in one row.

As shown in FIG. 4, a plurality of nozzles (nozzle holes) 51 are formed in a nozzle plate (nozzle forming substrate) 60 which constitutes an ink ejection surface 50a of the head 50. This nozzle plate 60 corresponds to the resin structural body of the present invention and is made of a resin material as described below. A lyophobic layer 62 having lyophobic properties with respect to ink is provided on the surface (ink ejection surface) of the nozzle plate 60. Furthermore, the inner wall faces of the nozzles 51 are rendered lyophilic.

The pressure chambers 52 provided corresponding to the respective nozzles 51 are approximately square-shaped in planar form, and a nozzle 51 and a supply port 54 are provided respectively at either corner of a diagonal of each pressure chamber 52. Each pressure chamber 52 is connected via the supply port 54 to a common flow channel 55. The common channel 55 is connected to ink supply tanks (not illustrated) forming an ink supply source, and the ink supplied from the ink supply tanks is distributed and supplied to each pressure chamber 52 via the common channel 55.

Piezoelectric elements 58 respectively provided with individual electrodes 57 are bonded to a diaphragm 56 which forms the upper face of the pressure chambers 52 and also serves as a common electrode, and each piezoelectric element 58 is deformed when a drive voltage is supplied to the corresponding individual electrode 57, thereby causing ink to be ejected from the corresponding nozzle 51. When ink is ejected, new ink is supplied to the pressure chambers 52 from the common flow channel 55, via the ink inlet ports 54.

In the present example, a piezoelectric element 58 is used as an ink ejection force generating device which causes ink to be ejected from a nozzle 50 provided in a head 51, but it is also possible to employ a thermal method in which a heater is provided inside the pressure chamber 52 and ink is ejected by using the pressure of the film boiling action caused by the heating action of this heater.

As illustrated in FIG. 3B, the high-density nozzle head according to the present embodiment is achieved by arranging a plurality of ink chamber units 53 having the above-described structure in a lattice fashion based on a fixed arrangement pattern, in a row direction which coincides with the main scanning direction, and a column direction which is inclined at a fixed angle of θ with respect to the main scanning direction, rather than being perpendicular to the main scanning direction.

More specifically, by adopting a structure in which a plurality of ink chamber units 53 are arranged at a uniform pitch d in line with a direction forming an angle of θ with respect to the main scanning direction, the pitch P of the nozzles projected so as to align in the main scanning direction is d×cos θ, and hence the nozzles 51 can be regarded to be equivalent to those arranged linearly at a fixed pitch P along the main scanning direction. Such configuration results in a nozzle structure in which the nozzle row projected in the main scanning direction has a high nozzle density of up to 2,400 nozzles per inch.

When implementing the present invention, the arrangement structure of the nozzles is not limited to the example shown in the drawings, and it is also possible to apply various other types of nozzle arrangements, such as an arrangement structure having one nozzle row in the sub-scanning direction.

Furthermore, the scope of application of the present invention is not limited to a printing system based on a line type of head, and it is also possible to adopt a serial system where a short head which is shorter than the breadthways dimension of the recording paper 16 is scanned in the breadthways direction (main scanning direction) of the recording paper 16, thereby performing printing in the breadthways direction, and when one printing action in the breadthways direction has been completed, the recording paper 16 is moved through a prescribed amount in the direction perpendicular to the breadthways direction (the sub-scanning direction), printing in the breadthways direction of the recording paper 16 is carried out in the next printing region, and by repeating this sequence, printing is performed over the whole surface of the printing region of the recording paper 16.

### Method of Manufacturing Nozzle Plate

Next, as one example of a method of manufacturing a resin molded article relating to an embodiment of the present invention, a method of manufacturing a nozzle plate 60 as shown in FIG. 4 (corresponding to a resin molded article according to the present invention) will be described.

### First Embodiment

FIGS. 5A to 5E are illustrative diagrams showing a method of manufacturing a nozzle plate relating to a first embodiment. The method of manufacturing a nozzle plate relating to the present embodiment comprises a fluorination processing step, a protective member forming step, a lyophobic layer forming step and a protective member removal step. The respective steps are described below.

### Fluorination Processing Step

Firstly, as shown in FIG. 5A, a nozzle forming substrate 100 having nozzle holes 102 is prepared. The nozzle forming substrate 100 is made of a resin material, and desirably, at least the surface (ink ejection surface) and the inner wall faces of the nozzles contain a CH₃ group or a CH₂ group or a CH group.

Possible examples of a resin material forming the nozzle forming substrate 100 are, for instance, a polyolefin (PO) material, or a PO+aromatic material, such as polystyrene (PS), or an aromatic compound such as polyether ether ketone (PEEK), and the like.

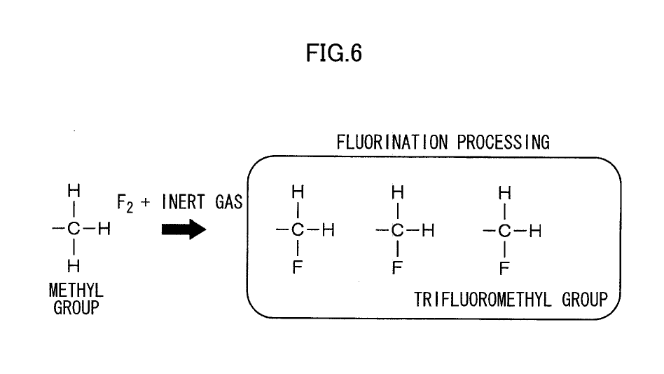

Thereupon, as shown in FIG. 5B, the surface of the nozzle forming substrate 100 and the inner wall faces of the nozzles are subjected to fluorination processing. For example, the fluorination processing is carried out by reacting a mixed gas of fluorine gas and nitrogen gas (inert gas) directly with the nozzle forming substrate 100 (see FIG. 6). By this means, a lyophobic layer (fluorinated layer) 104 is formed on the surface of the nozzle forming substrate 100 and the inner wall faces of the nozzles.

The fluorination process may be based on reaction with elemental (simple) fluorine gas, but as described in Japanese Patent Application Publication No. 2005-279175, since fluorine gas has high reactivity, then if the film is reacted directly with elemental fluorine gas, the reaction occurs too violently and even the C—C bond in the main chain is broken.

Therefore, in the present embodiment, fluorine gas is introduced into the reaction vessel (furnace) as a mixed gas combined with an inert gas such as helium, argon or nitrogen, and desirably, the reaction with fluorine gas is carried out at any temperature within a range that does not produce deformation or corrosion of the nozzle forming substrate 100. Furthermore, desirably, the fluorine gas concentration in the mixed gas in this case is equal to or greater than 0.01%. The extent of fluorination can be controlled by means of the concentration of the fluorine gas, the temperature of the reaction vessel and the reaction time.

Specific examples of a fluorination process is described in Japanese Patent Application Publication No. 2005-54067 and Japanese Patent Application Publication No. 2004-143622. More specifically, the nozzle forming substrate 100 is introduced into a processing vessel and the processing vessel is reduced to a pressure of 100 Pa or lower. Next, the atmosphere is substituted with an inert gas, such as nitrogen gas. Thereupon, fluorine gas is introduced into the vessel to a concentration of 0.1 to 99%. In this case, the pressure of the fluorine gas is desirably 1 to 1000 kPa. The processing time during which fluorine gas is brought into contact with the base material is 1 second to 10 days, and more desirably, 10 minutes to 10 hours. The processing temperature is −50° C. to 300° C., and more desirably, 0° C. to 100° C. Furthermore, in the case of at the same temperature, the longer the time is, the fluorine penetration depth becomes greater. Also in the case of at the same time, the higher the temperature is, the fluorine penetration depth becomes greater.

### Protective Member Forming Step

After carrying out the fluorination process as described above, as shown FIG. 5C, forming the organic film 104, as shown in FIG. 5B, a protective member 106 is formed on the lyophobic layer 104 on the surface of the nozzle forming substrate 100. For example, it is possible to use, for the protective member 106, a resin member such as an ultraviolet-curable resin, a metal or ceramic jig which covers and protects the nozzle surface, a protective tape, such as masking tape, or the like. A tape-shaped member is desirable, due to having excellent handling properties and enabling easy formation and detachment. More specifically, the protective tape may be attached on top of the organic film 104 on the surface of the nozzle forming substrate 100.

In the present embodiment, a desirable mode is one which uses a masking tape having a detachable (removable) acrylic adhesive on the surface of a base material, as the protective member 106. According to this mode, since a technique for attaching a masking tape is employed rather than attaching a protective member plate, then productivity is high, and since a solvent such as butyl acetate is not used, then problems of environmental impact do not arise. Furthermore, since a masking tape having a detachable acrylic adhesive on the surface of a base material is used, then the masking tape can be detached easily and therefore productivity is high in this respect as well.

A more desirable mode is one where the base material of the masking tape is constituted by a polyester film or polyethylene film. In the forming method according to an embodiment of the present invention, it is possible to use various materials as the base material of the masking tape, but it is also possible to maintain the strength of the tape even after the effects of plasma processing, by using polyester film or polyethylene film as the base material of the masking tape.

### Lyophobic Layer Removal Step

After forming the protective member 106, as shown in FIG. 5D, the lyophobic layer 104 formed on the inner wall faces of the nozzles of the nozzle forming substrate 100 is removed, while simultaneously lyophilic processing is carried out on these faces. The processing method used in this case is desirably plasma processing, acid processing, discharge processing, ultraviolet processing, electron beam processing, radiation processing or ozone gas processing, and of these, plasma processing (and desirably, plasma processing using a gas containing oxygen), ultraviolet processing and ozone gas processing (and desirably, high-purity ozone gas processing) are most desirable. By means of these processing methods, it is possible to render the inner wall faces of the nozzles lyophilic, by removing the lyophobic layer 104 from the inner wall faces of the nozzles which have been subjected to fluorination processing, thereby generating polar groups.

### Protective Member Removal Step

After rendering the inner wall faces of the nozzles lyophilic, as shown in FIG. 5E, the protective member 106 on the lyophobic layer 104 on the surface of the nozzle forming substrate 100 is removed. For example, if a masking tape having a detachable acrylic adhesive is used as the protective member 106, then it is possible readily to detach the masking tape which has been attached to the lyophobic layer 104 on the surface of the nozzle forming substrate 100, and therefore productivity can be raised.

In this way, it is possible to obtain the nozzle plate 60 shown in FIG. 4 as a resin structural body having a lyophobic surface and a lyophilic surface.

According to the present embodiment, after forming a lyophobic layer 104 by a fluorination process on the surface and the inner wall faces of the nozzles of a nozzle forming substrate 100 made of resin, a portion of the lyophobic layer 104 is removed while simultaneously carrying out lyophilic processing, whereby it is possible to manufacture the nozzle plate 60 which is a resin molded article having a lyophobic surface and a lyophilic surface, by means of a simple process. Furthermore, since gas processing by a fluorination process is used, then uniform processing (surface uniformity and conformal properties, and the like) can be achieved irrespectively of the shape of the base material, and low-temperature processing is also possible. Moreover, there is no need to take account of the coverage of the base material (namely, the nozzle forming substrate 100).

In the present embodiment, a mode is described in which a protective tape, such as masking tape, is used as the protective member 106, but the present invention is not limited to this. For example, possible modes are one which uses an elastic sheet made of silicone rubber or fluorine rubber, and one which uses a dry film. However, in the former mode, productivity is poor, and in the latter mode, after removing the lyophobic layer 104 on the inner wall faces of the nozzles, the dry film should be dissolved and removed by butyl acetate, and there are issues relating to environmental impact. On the other hand, a mode using a protective tape (more desirably, a masking tape having detachable acrylic adhesive) as the protective member 106 as in the present embodiment is desirable since the productivity is good and there are no problems in relation to environmental impact.

### Second Embodiment

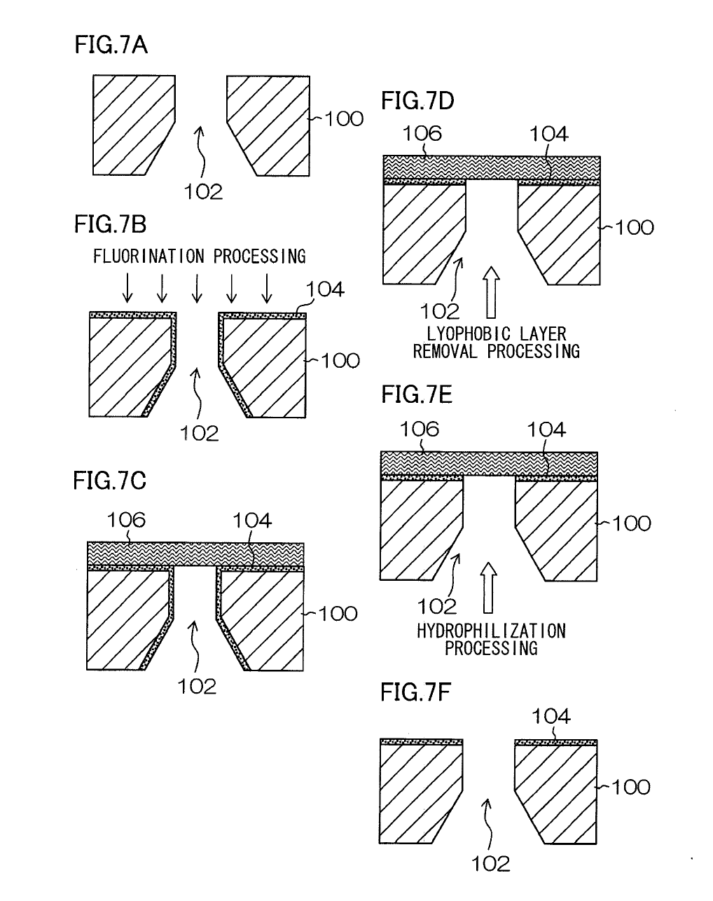

FIGS. 7A to 7F are illustrative diagrams showing a lyophobic treatment method relating to a second embodiment. In FIGS. 7A to 7F, elements which are the same as or similar to FIGS. 5A to 5E are labelled with the same reference numerals and description thereof is omitted here.

In the second embodiment, after carrying out the fluorination processing step through to the lyophobic layer removal step similarly to the first embodiment, a process for further enhancing the temporal stability of the lyophilic properties of the inner wall faces of the nozzles is carried out as a lyophilic processing step, as shown in FIG. 7E.

In the present embodiment, a gas process is used as a lyophilic processing step, and more specifically, it is desirable to employ ozone gas processing or gas processing using a mixed gas of fluorine gas and oxygen gas. According to gas processing of this kind, it is possible to uniformly carry out lyophilic processing on the inner wall faces of the nozzles, and a lyophilic layer having excellent temporal stability compared to plasma processing, or the like, can be formed on the inner wall faces of the nozzles.

In a mode which carries out gas processing using ozone gas, a step of exposing the nozzle forming substrate 100 to an ozone gas atmosphere is carried out. For example, if a polyimide film is processed for a processing time of 30 minutes at an ozone concentration of 20 vol % and a temperature of 60° C., then with plasma processing, the lyophilic properties decline in 2 to 3 days, whereas in the case of gas processing using ozone gas, the lyophilic properties are maintained for one month or longer. In this way, with gas processing using ozone gas, temporal stability is excellent compared to with plasma processing. Ozone gas processing can be used for oxidation processing, regardless of whether the material is a metal material, an organic material or an inorganic material.

In a mode where gas processing by means of a mixed gas of fluorine gas and oxygen gas is carried out, a step of exposing the nozzle forming substrate 100 to a mixed gas atmosphere is carried out. For example, only by switching the nitrogen gas used for the fluorination processing step to oxygen gas, it is possible to carry out processing inside a single processing vessel (chamber) and therefore productivity can be improved.

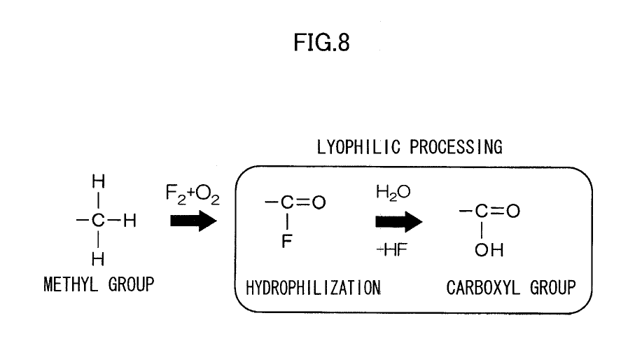

In a mode where gas processing is carried out using a mixed gas of fluorine gas and oxygen gas, as shown in FIG. 8, after exposing the nozzle forming substrate 100 to a mixed gas atmosphere, the nozzle forming substrate 100 is desirably exposed to a water vapor atmosphere. By exposing the nozzle forming substrate 100 to a water vapor atmosphere, it is possible to introduce a carboxyl group, and therefore the inner wall faces of the nozzles are rendered even more lyophilic. In contrast to ozone gas processing, this processing is only effective with organic material.

In a mode where the nozzle forming substrate 100 is exposed to a water vapor atmosphere, it is possible to introduce the water vapor without removing the mixed gas inside the processing vessel, or to introduce the water vapor after removing the mixed gas. However, the latter mode is desirable from the viewpoint of stabilizing the lyophilic processing.

After carrying out a lyophilic processing step as described above, the protective member 106 on the lyophobic layer 104 on the surface of the nozzle forming substrate 100 is removed as shown in FIG. 7F. In this way, it is possible to obtain the nozzle plate 60 shown in FIG. 4.

According to the second embodiment, since the lyophilic processing step is also carried out by gas processing, then uniform treatment by the gas processing (surface uniformity and conformal properties) is achieved and low-temperature processing becomes possible. Furthermore, by using gas processing, there is no need to take account of to adhesiveness with respect to the base material.

In this second embodiment, after the lyophilic processing step shown in FIG. 7E, the protective member removal step shown in FIG. 7F is carried out, but it is also possible to reverse the order of these steps. In other words, it is possible to carry out the lyophilic processing of the inner wall faces of the nozzles after removing the protective member 106. By adopting gas processing using ozone gas or mixed gas, the lyophobic layer 104 is not etched, even if there is no protective member 106, and therefore no particular problems arise if the protective member removal step is carried out before the lyophilic processing step as stated above.

In the respective embodiments described above, a method of manufacturing a nozzle plate 60 shown in FIG. 4 is described as one example of a method of manufacturing a resin molded article relating to an embodiment of the present invention, but the present invention is not limited to this and can also be applied similarly to a resin molded article constituted by a base material in which hole sections that are to become liquid flow channels (ink flow channels, and the like) are formed. Moreover, the present invention can be applied to a base material which does not have hole sections, and the positions where the lyophobic surface and the lyophilic surface are formed are not limited to the respective embodiments described above.

Methods of manufacturing a resin molded article, inkjet heads and electronic devices according to embodiments of the present invention have been described in detail above, but the present invention is not limited to the aforementioned examples, and it is of course possible for improvements or modifications of various kinds to be implemented, within a range which does not deviate from the essence of the present invention.

It should be understood that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A method of manufacturing a resin molded article, comprising:
a fluorination step of carrying out fluorination processing using a gas containing fluorine so as to form a lyophobic layer on at least a portion of a face of a base material made of resin;
a protective member formation step of forming a protective member on the portion of the face of the base material where the lyophobic layer has been formed;
a lyophobic layer removal step of, on the face of the base material where the protective member has not been formed, removing the lyophobic layer formed and simultaneously carrying out lyophilic processing; and
a protective member removal step of removing the protective member.

2. The method of manufacturing a resin molded article as defined in claim 1, wherein the gas used in the fluorination processing is a mixed gas containing fluorine gas and inert gas.

3. The method of manufacturing a resin molded article as defined in claim 1, wherein in the lyophobic layer removal step, the lyophobic layer is removed by plasma processing, acid processing, discharge processing, ultraviolet processing, electron beam processing, radiation processing or ozone gas processing.

4. The method of manufacturing a resin molded article as defined in claim 1, further comprising a lyophilic step of carrying out additional lyophilic processing on the face of the base material where the lyophobic layer has been removed, after the lyophobic layer removal step.

5. The method of manufacturing a resin molded article as defined in claim 4, wherein the lyophilic step of carrying out additional lyophilic processing is performed by gas processing.

6. The method of manufacturing a resin molded article as defined in claim 5, wherein the lyophilic step of carrying out additional lyophilic processing includes a step of exposing the base material to an ozone gas atmosphere.

7. The method of manufacturing a resin molded article as defined in claim 5, wherein the lyophilic step of carrying out additional lyophilic processing includes a step of exposing the base material to a mixed gas atmosphere of fluorine gas and oxygen gas.

8. The method of manufacturing a resin molded article as defined in claim 7, wherein the lyophilic step of carrying out additional lyophilic processing further includes a step of exposing the base material to a water vapor atmosphere after exposing the base material to the mixed gas atmosphere.

9. The method of manufacturing a resin molded article as defined in claim 4, wherein the lyophilic step is carried out before the protective member removal step.

10. The method of manufacturing a resin molded article as defined in claim 4, wherein the lyophilic step is carried out after the protective member removal step.

11. The method of manufacturing a resin molded article as defined in claim 1, wherein a hole section to form a liquid flow channel is provided in the base material, the lyophobic layer is formed by subjecting a surface of the base material and an inner wall face of the hole section to the fluorination processing, the protective member is formed on the lyophobic layer on the surface of the base material, the lyophobic layer formed on the inner wall face of the hole section is removed while simultaneously the lyophilic processing is carried out on the inner wall face of the holes section, and the protective member is removed.

12. The method of manufacturing a resin molded article as defined in claim 11, wherein the base material is a nozzle forming substrate in which a nozzle hole is formed.

13. The method of manufacturing a resin molded article as defined in claim 1, wherein the protective member is a detachable tape.

14. The method of manufacturing a resin molded article as defined in claim 13, wherein the detachable tape has a removable acrylic adhesive.

15. The method of manufacturing a resin molded article as defined in claim 13, wherein the detachable tape has a base made from a polyester film or a polyethylene film.

16. An inkjet head comprising a resin molded article manufactured by the method of manufacturing a resin molded article defined in claim 1.

17. An electronic device comprising the inkjet head as defined in claim 16.
